(19) United States
(12) Patent Application Publication
(10) Pub. No.: US 2007/0136699 A1
(43) Pub. Date: Jun. 14, 2007

(54) Dependency matrices and methods of using the same for testing or analyzing an integrated circuit

(75) Inventors: Lyle E. Grosbach, Rochester, MN (US); Kent H. Haselhorst, Byron, MN (US); Chad B. McBride, Rochester, MN (US); Quentin G. Schmierer, Rochester, MN (US)

Correspondence Address: Leslie J. Payne;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 11/297,314

(22) Filed: Dec. 8, 2005

(51) Int. Cl. G06F 17/50

(52) U.S. Cl. 716/4

(57) ABSTRACT

In a first aspect, a method of testing or analyzing an integrated circuit (IC) is provided. The method includes the steps of (1) generating information about a dependency between components of the IC based on a netlist describing the IC; and (2) reducing the generated information by at least one of (a) combining portions of the information about components with a common dependency; and (b) eliminating a portion of the information about at least a first component that does not depend on another component of the IC. Numerous other aspects are provided.

### FIELD OF THE INVENTION

The present invention relates generally to integrated circuits, and more particularly to dependency matrices and methods of using the same for testing or analyzing an integrated circuit.

### BACKGROUND

Testing or analyzing a conventional large scale integrated circuit is complex because of the large number of component states (e.g., latch states) that must be tested or analyzed. Further, for such conventional systems, if a single-cycle state space is made a function of time (e.g., a multi-cycle state space), over a small window the multi-cycle state space becomes extremely large. Accordingly, improved methods and apparatus for testing or analyzing an integrated circuit are desired.

### SUMMARY OF THE INVENTION

In a first aspect of the invention, a method of testing or analyzing an integrated circuit (IC) is provided. The method includes the steps of (1) generating information about a dependency between components of the IC based on a netlist describing the IC; and (2) reducing the generated information by at least one of (a) combining portions of the information about components with a common dependency; and (b) eliminating a portion of the information about at least a first component that does not depend on another component of the IC.

In a second aspect of the invention, a method of improving a process is provided. The method includes the steps of (1) generating information about a dependency between sub-processes of the process; and (2) reducing the generated information by at least one of (a) combining portions of the information about sub-processes with a common dependency; and (b) eliminating a portion of the information about at least a first sub-process that does not depend on another sub-process of the process.

In a third aspect of the invention, a method of improving a structure is provided. The method includes the steps of (1) generating information about a dependency between components of the structure; and (2) reducing the generated information by at least one of (a) combining portions of the information about components with a common dependency; and (b) eliminating a portion of the information about at least a first component that does not depend on another component of the structure.

In a fourth aspect of the invention, a first apparatus is provided for testing or analyzing an IC. The first apparatus is a dependency information generation tool having a processor coupled to a memory. The dependency information generation tool is adapted to generate information about a dependency between components of the IC based on a netlist describing the IC.

In a fifth aspect of the invention, a second apparatus is provided for testing or analyzing an IC. The second apparatus is a dependency information reduction tool having a processor coupled to a memory. The dependency information reduction tool is adapted to (1) receive generated information about a dependency between components of the IC based on a netlist describing the IC; and (2) reduce the generated information by at least one of (a) combining portions of the information about components with a common dependency; and (b) eliminating a portion of the information about at least a first component that does not depend on another component of the IC.

In a sixth aspect of the invention, a first system for testing or analyzing an integrated circuit (IC) is provided. The system includes (1) a dependency information generation tool; and (2) a dependency information reduction tool coupled to the dependency information generation tool. The dependency information generation tool is adapted to generate information about a dependency between components of the IC based on a netlist describing the IC. The dependency information reduction tool is adapted to reduce the generated information by at least one of (a) combining portions of the information about components with a common dependency; and (b) eliminating a portion of the information about at least a first component that does not depend on another component of the IC.

In a seventh aspect of the invention, a first computer program product is provided. The first computer program product includes a medium readable by a computer, the computer readable medium having computer program code adapted to generate information about a dependency between components of an IC based on a netlist describing the IC.

In an eighth aspect of the invention, a second computer program product is provided. The second computer program product includes a medium readable by a computer, the computer readable medium having computer program code adapted to (1) receive generated information about a dependency between components of the IC based on a netlist describing the IC; and (2) reduce the generated information by at least one of (a) combining portions of the information about components with a common dependency; and (b) eliminating a portion of the information about at least a first component that does not depend on another component of the IC. Numerous other aspects are provided in accordance with these and other aspects of the invention. Each computer program product described herein may be carried by a medium readable by a computer (e.g., a carrier wave signal, a floppy disc, a compact disc, a DVD, a hard drive, a random access memory, etc.).

Other features and aspects of the present invention will become more fully apparent from the following detailed description, the appended claims and the accompanying drawings.

### BRIEF DESCRIPTION OF THE FIGURES

FIG. 1 is a block diagram of a system for testing or analyzing an integrated circuit (IC) in accordance with an embodiment of the present invention.

FIG. 2 is a diagram illustrating a process flow of an exemplary method of testing or analyzing an IC in accordance with an embodiment of the present invention.

FIG. 3 is a block diagram of an exemplary IC to be tested or analyzed in accordance with an embodiment of the present invention.

FIG. 4 is a block diagram of an associative array created during the exemplary method of testing or analyzing an IC in accordance with an embodiment of the present invention.

FIG. 5 illustrates exemplary dependency information generated during the exemplary method of testing or analyzing an IC in accordance with an embodiment of the present invention.

FIG. 6 illustrates an exemplary reduction of the dependency information in accordance with an embodiment of the present invention.

### DETAILED DESCRIPTION

The present invention provides methods and apparatus improving a process and/or performance of a structure. In one embodiment, the present methods and apparatus may be employed to improve verification of a large scale integrated circuit (IC). In such an embodiment, the present invention may provide an efficient method of determining functional dependencies of the large scale IC. For example, the present invention may generate one or more matrices describing how components of the IC are related. An algorithm may be employed to reduce one or more of such matrices to include only information about two or more related components, respectively. Such matrices may be used to reduce IC testing or IC analysis complexity.

More generally, the present invention may provide methods and apparatus for generating information about dependencies of sub-processes of the process. The information generated may efficiently describe sub-processes of the process (e.g., reduce an amount of data employed to describe the sub-processes). For example, the information may include one or more matrices, each of which may describe a relationship between two or more related (e.g., dependent) sub-processes of the process. Alternatively, the present invention may provide methods and apparatus for generating information about dependencies of components of a structure. The information generated may efficiently describe components of the structure (e.g., reduce an amount of data employed to describe the components). For example, the information may include one or more matrices, each of which may describe a relationship between two or more related components of the structure.

Such information may be employed to improve testing (e.g., simulation testing) or analysis of the process by testing or analyzing related sub-processes together or to improve testing or analysis of the apparatus by testing or analyzing related components together. For example, by testing or analyzing related sub-processes of a process (or components of a structure) together, an overall amount of verification required to test or analyze the process (or structure) may be reduced. The results of such improved testing or analyzing may be employed to improve the process or performance of the structure. In this manner, the present invention provides methods and apparatus of improving a process and/or performance of a structure.

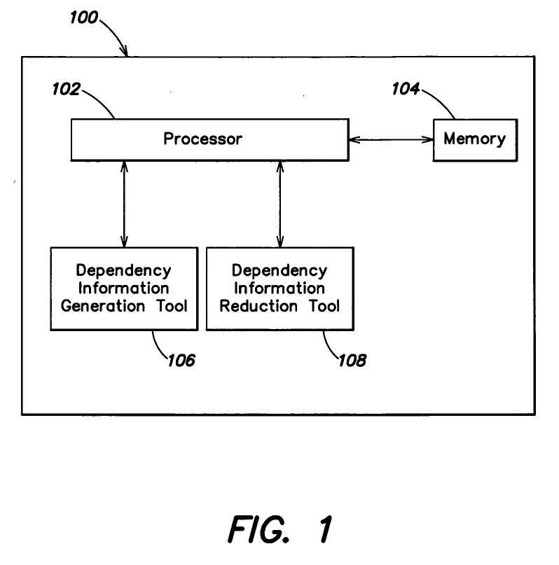

FIG. 1 is a block diagram of a system for testing or analyzing an integrated circuit (IC) in accordance with an embodiment of the present invention. With reference to FIG. 1, the system 100 for testing or analyzing an IC may be a computer or the like. The system 100 may include a processor 102 adapted to execute instructions (e.g., code). The processor 102 may be coupled to memory 104 adapted to store data. Further, the system 100 may include a dependency information generation tool 106 coupled to the processor 102. The dependency information generation tool 106 may be adapted to generate information about a dependency between components (or functions performed thereby) of an IC based on a netlist describing the IC. The system 100 may include a dependency information reduction tool 108 coupled to the processor. The dependency information reduction tool 108 may be adapted to receive the information generated about the dependency between components (or functions) of the IC and reduce such information. The dependency information reduction tool 108 may employ an algorithm to reduce the generated information. As described below, the reduced information may be employed to test or analyze the IC. The reduced information may reduce an overall number of tests or analysis that may be required to test or analyze the IC.

In some embodiments, the dependency information generation tool 106 and/or the dependency information reduction tool 108 may be software which is executed by the processor 102. Alternatively, the dependency information generation tool 106 and/or the dependency information reduction tool 108 may be hardware or a computer program product.

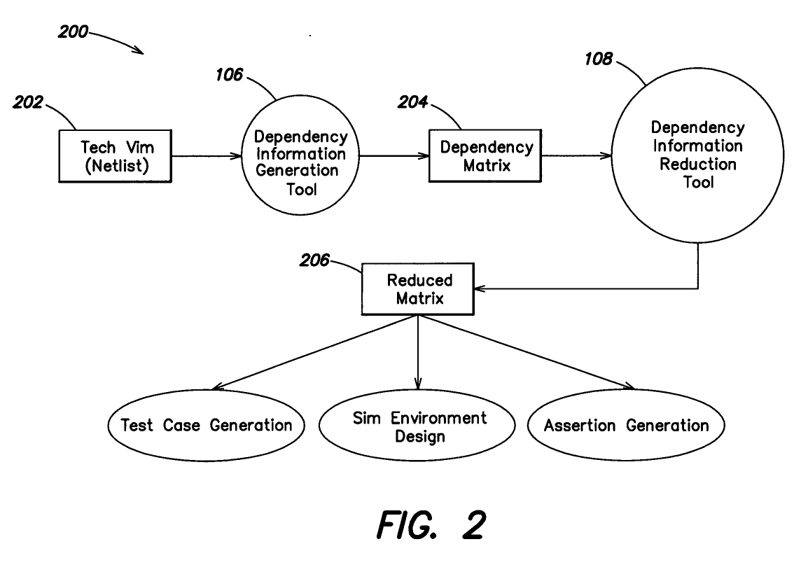

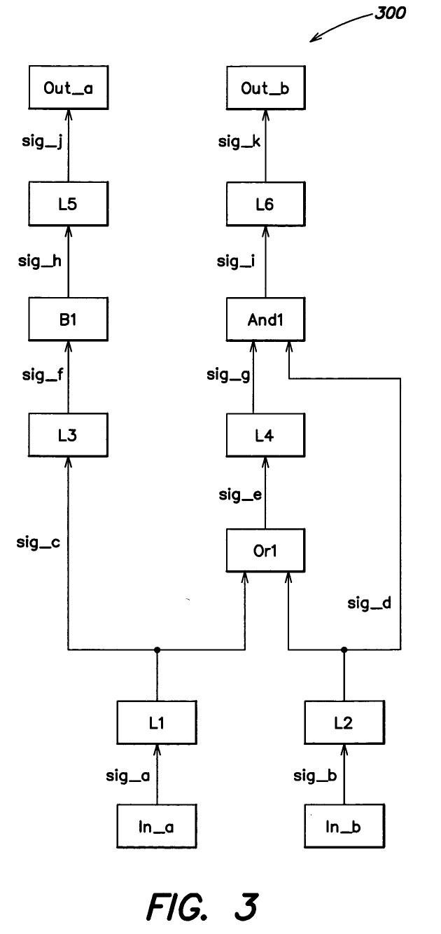

FIG. 2 is a diagram illustrating a process flow of an exemplary method 200 of testing or analyzing an IC in accordance with an embodiment of the present invention. With reference to FIG. 2, during the exemplary method 200 of testing or analyzing an IC, the dependency information generation tool 106 may receive a netlist (e.g., a tech vim) 202 describing the IC. An exemplary IC is described below with reference to FIG. 3. Code employed (e.g., by a circuit designer) to design an IC may be synthesized or compiled to form the netlist 202. In this manner, the netlist 202 may describe components of the IC with a resolution (e.g., down to a transistor level or down to logic gate level).

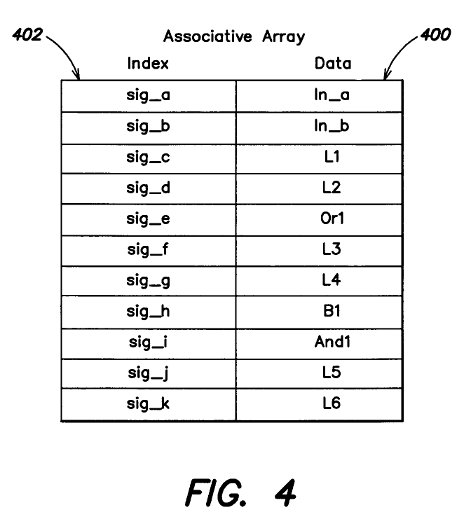

The dependency information generation tool 106 may employ the netlist 202 to determine dependency between components (or functions performed thereby) of the IC and output information describing such dependency. Such information about a dependency between components of the IC may be output as a dependency matrix. An exemplary dependency matrix 204 is described below with reference to FIG. 4. For example, the dependency information generation tool 106 may parse the netlist 202 to create the dependency matrix 204.

The dependency information reduction tool 108 may be adapted to receive the dependency information (e.g., matrix 204) as input and reduce the dependency information when possible. For example, the dependency information reduction tool 108 may combine portions of the dependency information about components having a common dependency. Such components may be grouped together into a larger functional component. Alternatively or additionally, the dependency information reduction tool 108 may remove information about at least a first component that does not depend on another component included in the IC. The dependency information reduction tool 108 may output such reduced information (e.g., in the form of a reduced matrix 206).

The reduced matrix 206 may be employed to improve testing or analyzing of the IC. For example, the reduced matrix 206 may improve test case generation, simulation environment design and/or assertion generation. A simulation environment may refer to a unit under test or analysis and one or more models of blocks that may communicate with the unit under test or analysis. A test or analysis case may describe how the one or more models of blocks operate. Assertion generation may be part of a simulation and employed to provide a failure condition if an untrue condition is encountered. By employing the reduced matrix during an IC test or analysis, functions performed by independent components of the IC may not need to be tested or analyzed with remaining components of the IC. In this manner, an overall number of tests or analysis required to test or analyze the IC may be reduced, thereby improving testing or analysis efficiency.

FIG. 3 is a block diagram of an exemplary IC to be tested or analyzed in accordance with an embodiment of the present invention. With reference to FIG. 3, the exemplary IC 300 may include a first input pin In_a, which may source a first signal sig_a, coupled to a first latch L1 of the IC 300. Similarly, the exemplary IC 300 may include a second input pin In_b, which may source a signal sig_b, coupled to a second latch L2 of the IC 300. The first and second latches L1, L2 may couple to a first logic gate (e.g., an OR gate Or 1).

Additionally, the first latch L1, which may source a signal sig_c, may couple to a third latch L3. Similarly, the second latch L2, which may source a signal sig_d, may couple to a second logic gate (e.g., an AND gate And 1). The first logic gate Or 1, which may source a signal sig_e, may couple to a fourth latch L4 of the IC 300. The third latch L3, which may source a signal sig_f, may couple to a third logic gate (e.g., a repowering buffer B1 adapted to maintain signal polarity and/or add drive strength for a heavily loaded or very long net) and the fourth latch L4, which may source a signal sig_g, may couple to the second logic gate And 1. The third logic gate B1, which may source a signal sig_h, may couple to a fifth latch L5 of the IC 300 and the second logic gate And 1, which may source a signal sig_i, may couple to a sixth latch L6 of the IC 300. The fifth latch L5, which may source a signal sig_j, may couple to a first output pin Out_a of the IC 300. Similarly, the sixth latch L6, which may source a signal sig_k, may couple to a second output pin Out_b of the IC 300. The design of the IC 300 is exemplary, and therefore, the IC 300 may include a larger or smaller amount of components and/or different components, which may be coupled in a different manner.

FIG. 4 is a block diagram of an associative array 400 created during the exemplary method 200 of testing an IC in accordance with an embodiment of the present invention. As stated to generate dependency information (e.g., in the form of a dependency matrix 204) about components of the IC (300 in FIG. 3), the dependency information generation tool (106 in FIG. 1) may parse the netlist (e.g., tech vim) 202 for instances of components (e.g., logic elements such as inverters, buffers, and the like). The dependency information generation tool 106 may assume that the Random Logic Macros (RLMS) are flattened. In this manner, latch elements included in the IC 300 may be visible in the netlist (except for latch elements inside arrays and/or SRAMs). However, the dependency information generation tool 106 may employ a different resolution (e.g., which may be provided by a user) to generate dependency information. For example, a resolution may be provided such that latch dependency information, signal dependency information, I/O dependency information, or the like may be generated by the dependency information generation tool 106.

With reference to FIG. 4, while generating the dependency information about components of the IC 300, the dependency information generation tool 106 may create the associative array 400. Interconnect signals may be stored in the associative array 400 indexed by signal name. For example, the associative array 400 may store names of components (e.g., boxes) which source respective signals. Names of such signals may be employed as respective indexes 402 to the associative array 400. The structure of the associative array 400 may enable the dependency information generation tool 106 to quickly and easily traverse logic paths (e.g., crawl through cones of logic) of the IC 300 from a given start point, such as an input pin In_a, In_b to an end point, such as an output pin Out_a, Out_b (e.g., an IO), or vice versa, while generating the dependency information about components of the IC 300. In this manner, the dependency information generation tool 106 may recursively trace logic paths (e.g., a cone) for components (e.g., latches L1-L6) included in the IC 300. For example, while recursively tracing a path for a selected starting component of the IC 300, the dependency information generation tool 106 may place a checkmark (e.g., may set a bit) in an entry of the dependency matrix 400 as the trace encounters other components (e.g., latches) along the way to indicate the component just found has a dependency on the starting component. The recursive trace may continue traverse the logic paths until a desired endpoint is found.

The following pseudo code may describe a tracing algorithm employed by the dependency information generation tool 106 to traverse logic paths of the IC 300 while generating the dependency information.

void TraceOnSourceBook(sourcebookname)
{

For Every Input on sourcebookname {

signal = GetNextInputSignalName;
nextsourcebook = AssociativeArray[signal];
If nextsourcebook = Latch {

add_dependency_to_matrix(sourcebookname, nextsourcebook);

}
if nextsourcebook != IO {

TraceOnSourceBook(nextsourcebook);

}

}

}

The above pseudo code is exemplary, and therefore, a larger or smaller amount of and/or different pseudo code may be employed.

While tracing logic paths of the IC 300, the dependency information generation tool 106 should avoid getting trapped in a loop of a logic path which causes the crawl through the logic paths to get stuck in the loop. Therefore, in some embodiments, the dependency information generation tool 106 may maintain a signal table indicating that respective paths of signals have already been traversed. Such signal table may be reset when a new source latch is selected from which a trace begins. The pseudo code illustrated above may be modified to prevent the crawl through logic from getting stuck in a loop. For example, the pseudo code may be modified to keep track of signals already used to prevent placing multiple entries into loops. In this manner, while traversing logic paths of an IC to obtain a table of source book, net and destination book information, the same path may be traversed only once so the table may include the source book, destination book and name of the net between the books. For every net source-net-sink (e.g., destination) combination an entry may be added to the table only if such entry does not already exist, otherwise the logic circuit is in a loop, and consequently, the logic crawl moves on to the next item to be processed.

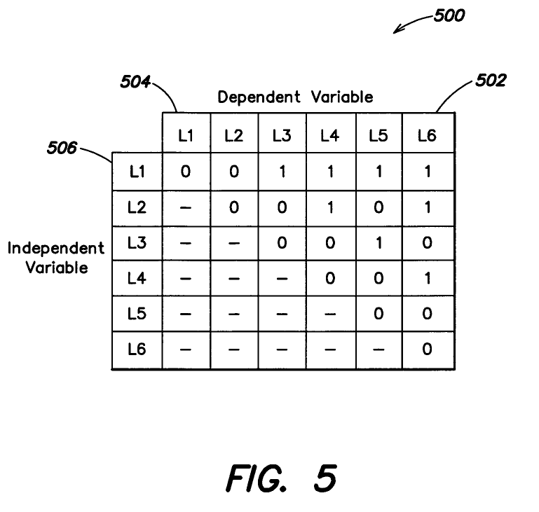

In this manner, the dependency information generation tool 106 may generate dependency information (e.g., a dependency matrix 204) about components (e.g., latches L1-L6) of the IC 300. Details of exemplary dependency information are described below with reference to FIG. 5.

FIG. 5 illustrates exemplary dependency information generated during the exemplary method 200 of testing or analyzing an IC in accordance with an embodiment of the present invention. With reference to FIG. 5, the dependency information 500 about components of the IC 300 generated during the exemplary method 200 of testing or analyzing an IC 300 may be included in a matrix 502. Columns 504 of the matrix 502 may correspond to components of the IC 300 which source a signal. For example, columns 504 of the matrix 502 may correspond to latches L1-L6 which source a signal. Such columns may represent dependent variables (e.g., components). Rows 506 of the matrix 502 may correspond to components on which the source components depend. Therefore, such rows may represent independent variables (e.g., components). An asserted bit in the intersection of a column 504 and row 506 may indicate the component corresponding to the column 504 depends on the component corresponding to the row 506. Alternatively, a deasserted bit in the intersection of a column 504 and row 506 may indicate the component corresponding to the column 504 does not depend on the component corresponding to the row 506. For example, a signal of a high state (e.g., a logic “1”) in the column corresponding the third latch L3 and the row corresponding the first latch L1 may indicate the third latch L3 of the IC 300 depends on the first latch L1 of the IC 300. Therefore, the dependency information 500 indicates (1) the sixth latch L6 depends on the first, second and fourth latches L1, L2, L4; (2) the fifth latch L5 depends on the first and third latches L1, L3; (3) the fourth latch L4 depends on the first and second latches L1, L2; (4) the third latch L3 depends on the first latch L1; and the first and second latches L1, L2 do not depend on other latches of the IC 300.

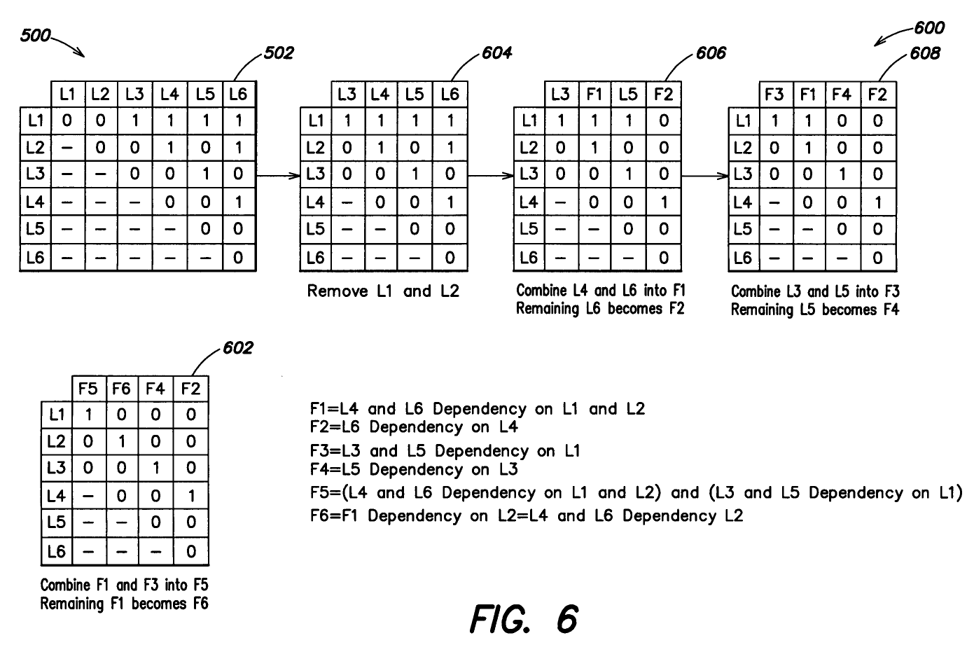

The information 500 about dependency between components of the IC 300 may be provided to the dependency information reduction tool 108 which may reduce an amount of the information 500. The reduced information may be employed to improve testing or analysis of the IC 300. More specifically, the reduced information may reduce an overall number of tests or analysis required to test or analyze the IC 300, thereby improving testing or analyzing efficiency. The dependency information reduction tool 108 may employ an algorithm to reduce the generated information 500. An exemplary algorithm employed by the dependency information reduction tool 108 to reduce the generated information is described below with reference to FIG. 6.

FIG. 6 illustrates an exemplary reduction 600 of the dependency information in accordance with an embodiment of the present invention. With reference to FIG. 6, the dependency information reduction tool 108 may employ an algorithm to reduce the generated information. For example, the dependency information reduction tool 108 may reduce information by combining portions of the information about components with a common dependency and/or by eliminating a portion of the information about at least a first component that does not depend on another component of the IC 300. The dependency information reduction tool 108 may expand (e.g., add to) or duplicate portions of the generated information if such expansion (e.g., addition of information) or duplication may enable a subsequent reduction in the amount of the generated information. For example, assuming the generated information is a dependency matrix, the algorithm to reduce the generated information employed by the dependency information reduction tool 108 may include one or more of the following steps:
(1) column or row reduction;
(2) column or row expansion; and
(3) column or row elimination.
   However, the algorithm may include a larger or smaller number of and/or different steps. The dependency information reduction tool 108 may search the generated information for portions with a similar dependency. For example, the dependency information reduction tool 108 may search the generated information for columns 504, respective portions of which have common dependency. The columns 504 may correspond to respective IC components that source a signal. Portions of such columns 504 may be combined into one of the columns 504, and the column name may be changed to indicate a functional component that represents the IC components. Further, columns 504 corresponding to respective components that are exactly the same may be reduced to a single column 504 with a name change to represent a functional component that includes the respective components. The column or row reduction step may be assigned a higher priority than remaining steps of the algorithm. Therefore, the dependency information reduction tool 108 may attempt to reduce columns 504 and/or rows 506 of the dependency matrix before performing the steps below.

Additionally, the dependency information reduction tool 108 may determine whether portions of the generated information may be expanded or duplicated. Portions of the generated information may be expanded or duplicated if such expansion or duplication of information may enable a subsequent reduction in the generated information. For example, the dependency information reduction tool 108 may expand (e.g., add information to) or duplicate a column 504 of the generated information if a subset of that column 504 may be combined with another column 504 and thereby reduced. In this manner, the net effect of such steps is that the generated information (e.g., dependency matrix) may remain the same size or may get smaller. The dependency information reduction tool 108 may attempt to expand or duplicate columns 504 or rows 506 having the largest number of common subsets before remaining columns 504 or rows 506 having common subsets.

The dependency information reduction tool 108 may reduce portions of the generated information corresponding to at least a first component (e.g., original component or functional component) that does not depend on other components in the IC 300. For example, as the dependency information reduction tool 108 performs reductions and possibly expansions of the dependency matrix 500, a column 504 corresponding to a component may end up with no dependencies on remaining components. Therefore, the dependency information reduction tool 108 may remove such column 504 from the dependency matrix. The dependency information reduction tool 108 may be adapted to keep track of an original components or functional components corresponding to columns 504 or rows 506 that have been eliminated because such components or functional components may imply complete independence from the rest of the IC 300. Therefore, such original components or functional components may need to be tested, verified or analyzed independently. Through the use of matrix reduction techniques described above, a dependency matrix can be reduced to show not only bit dependency but larger level functional dependency. It should be noted that if two components (or functions performed thereby) are independent, the present methods and apparatus may assume there is no need to dependently verify them.

The dependency information reduction tool 108 may employ the algorithm above to reduce the dependency information (e.g., matrix) 500 about components of the IC 300 generated by the dependency information generation tool 106. For example, the dependency information reduction tool 108 may remove columns L1 and L2 from the matrix 500 because components L1 and L2 do not depend on other latches in the IC 300, thereby forming a first intermediate matrix 604.

Portions of columns L4 and L6 having a common dependency may be combined into a column corresponding to a functional component F1, which may represent a combination of components L4 and L6. Therefore, column F1 may indicate component L4's and L6's dependency on components L1 and L2. Further, remaining portions of the column L6 may be placed in a column representing functional component F2. Column F2 may indicate component L6's dependence on component L4. In this manner, a second intermediate matrix 606 may be formed.

Portions of columns L3 and L5 having a common dependency may be combined into a column representing functional component F3, which may represent a combination of components L3 and L5. Column F3 may indicate component L3's and L5's dependence on component L1. Further, remaining portions of the column L5 may be placed in a column for functional component F4. Column F4 may indicate component L5's dependence on component L3. In this manner, a third intermediate matrix 608 may be formed.

Portions of columns F1 and F3 having a common dependency may be combined into a column for a functional component F5, which may represent a combination of functional components F1 and F3. Column F5 may indicate component L4's and L6's dependence on components L1 and L2 and may indicate component L3's and L5's dependence on component L1. Further, remaining portions of the column F1 may be placed in a column representing functional component F6. Column F6 may indicate component F1's dependence on component L2 which is component L4's and L6's dependence on component L2. In this manner, the reduced matrix 602 may be formed.

The reduced matrix 602 may be employed (e.g., by the system 100) to improve testing or analysis of the IC 300. For example, the reduced matrix 602 may reduce an overall amount of tests or analysis required to fully test or analyze the IC 300, thereby increasing testing or analyzing efficiency. For example, without the reduced matrix 602, a large number of tests or analysis may be required to fully test or analyze all components (e.g., latches L1-L6) in the IC 300. More specifically, testing or analyzing an “on” and “off” state for each of six latches L1-L6 of the IC 300 may require 4096 (2¹²) tests or analyses to be performed. In contrast, using the reduced matrix 602, two tests or analyses may be required to test or analyze component L1, two tests or analyses may be required to test or analyze component L2, four (2²) tests or analyses may be required to test or analyze functional component F2, four (2²) may be required to test or analyze functional component F4, sixty-four tests or analyses (2⁶) may be required to test or analyze functional component F5 and eight (2³) tests or analyses may be required to test or analyze functional component F6. More specifically, L1 and L2 may be tested or analyzed independently (e.g., optimized out of the test or analysis of remaining components L3-L6 of the IC 300.) Consequently, the reduced matrix 602 may enable the IC 300 to be tested or analyzed using eighty-four tests or analyses, which is a 98% reduction in a number of tests or analyses required to fully test or analyze the IC 300. In this manner, the reductions (described above) in the dependency matrix 500 to yield the reduced matrix 602 may result in a state-space of thirty-two tests or analyses as opposed to 144 tests or analyses needed for the complete circuit. The number of tests or analyses may be based on every bit in combination with every other bit. In this manner, the present invention may provide an efficient method of determining functional dependencies of components on a large scale integrated chip using dependency matrices and reduction techniques as described above.

Consequently, the present methods and apparatus may avoid disadvantages of conventional systems (e.g., for testing or analyzing an IC). More specifically, verification of a large scale integrated chip using such conventional systems becomes very complex as the number of chip components (e.g., latch elements) increases. For example, a total single-cycle state space on a chip that has 1000 latches is 2¹⁰⁰⁰≈1.0715E301 states, each of which is verified during a chip test or analysis. Further, for such conventional systems, if you then take the single-cycle state space and make it a function of time (e.g., a multi-cycle state space), over a small window the multi-cycle state space becomes extremely large. For example, in the exemplary conventional system described above, over fifteen cycles, the state-space becomes at least ≈(1.0715E301)¹⁵ states. Consequently, it is unrealistic and may be impossible to employ conventional methods which test or analyze the total multi-cycle state space even for such simple 1000-latch exemplary conventional system design during a window of fifteen cycles. In contrast, the present invention may employ connectivity information of the netlist 202 to learn which components (or functions or groups of functions performed thereby) may need to be tested or analyzed with other groups of components (or functions). For example, the present invention may employ the netlist 202 to formally determine dependency between components (or functions or groups of functions performed thereby) and generate a reduced matrix 602 describing such dependency.

The reduced matrix 602 may then be used to decrease a total state-space, and therefore, may improve a time required to find problems of (e.g., bugs in) an IC design. For example, the present methods and apparatus may decrease overhead created by unnecessary testing or analyzing. Further, the present methods and apparatus may provide clearer test or analysis cases and/or simulation environments. In this manner, the present invention may provide a thorough (e.g., complete) view of the functional dependency (e.g., of components such as logic devices, transistors, wiring and/or the like) of an IC design. Without such view, an IC designer, verification engineer, or similar person, may only speculate about such dependency based on his individual understanding of the design. The dependency information generated by the present methods and apparatus may be employed as feedback for the simulation environment and enable the designer, engineer or similar person to determine whether changes should be made to a given IC design. Once a dependency matrix 502 has been established using the present methods and apparatus, a time to re-generate a new dependency matrix (e.g., based on revisions to a previous IC design) may decrease exponentially as you approach a final IC design (e.g., hardware freeze), because fewer and fewer changes are being made to such design. In this manner, a time required to test or analyze such revised IC design may be reduced. Consequently, the dependency matrices 502, 602 described above may become more and more valuable as an IC design approaches finalization.

A resolution of IC components tested or analyzed above (e.g., for which dependency information is generated) is latches L1-L6. However, a finer or coarser resolution may be employed. For example, the resolution of IC components tested or analyzed may be transistors, and therefore, dependency information about transistors of the IC 300 may be generated).

The foregoing description discloses only exemplary embodiments of the invention. Modifications of the above disclosed apparatus and methods which fall within the scope of the invention will be readily apparent to those of ordinary skill in the art. For instance, the present methods and apparatus are described above with reference to an IC 300 to be tested or analyzed. However, in a first broader aspect, the present invention may include methods and apparatus for improving a process by (1) generating information about a dependency between sub-processes of the process; and (2) reducing the generated information by at least one of (a) combining portions of the information about sub-processes with a common dependency; and (b) eliminating a portion of the information about at least a first sub-process that does not depend on another sub-process of the process. The reduced information may be employed to test or analyze the process. Alternatively or additionally, in second broader aspect, the present invention may include methods and apparatus for improving a structure by (1) generating information about a dependency between components of the structure; and (2) reducing the generated information by at least one of (a) combining portions of the information about components with a common dependency; and (b) eliminating a portion of the information about at least a first component that does not depend on another component of the structure. The reduced information may be employed to test or analyze the structure.

Accordingly, while the present invention has been disclosed in connection with exemplary embodiments thereof, it should be understood that other embodiments may fall within the spirit and scope of the invention, as defined by the following claims.

The invention claimed is:

1. A method of testing or analyzing an integrated circuit (IC), comprising:
generating information about a dependency between components of the IC based on a netlist describing the IC; and
reducing the generated information by at least one of:
combining portions of the information about components with a common dependency; and
eliminating a portion of the information about at least a first component that does not depend on another component of the IC.

2. The method of claim 1 further comprising employing the reduced information to test or analyze the IC.

3. The method of claim 2 wherein employing the reduced information to test or analyze the IC includes reducing a number of tests or analyses employed to test or analyze the IC.

4. The method of claim 1 wherein:
generating information about the dependency between components of the IC based on a netlist describing the IC includes generating a matrix of information about the dependency between components of the IC based on a netlist describing the IC; and
reducing the generated information includes reducing the generated information by at least one of:
combining rows or columns of the information about components with a common dependency;
eliminating a row or a column of the information about at least a first component that does not depend on another component of the IC; and
at least one of adding additional information to the generated information so as to enable further reduction of the generated information and duplicating a portion of the generated information so as to enable further reduction of the generated information.

5. The method of claim 4 wherein:
adding additional information to the generated information so as to enable further reduction of the generated information includes adding additional information to the generated information so that one or more portions of the additional information may be combined with a portion of the generated information; and
duplicating a portion of the generated information so as to enable further reduction of the generated information includes duplicating a portion of the generated information so that one or more portions of the duplicated information may be combined with a portion of the generated information.

6. An apparatus for testing or analyzing an integrated circuit (IC), comprising:
a dependency information generation tool having a processor coupled to a memory;
wherein the dependency information generation tool is adapted to generate a matrix of information about the dependency between components of the IC based on the netlist describing the IC.

7. The apparatus of claim 6 wherein:
a column of the matrix corresponds to a component which sources a signal in the IC; and
a row of the matrix indicates a component of the IC on which the component which sources the signal depends.

8. The apparatus of claim 6 wherein components of the IC include transistors or logic gates of the IC.

9. An apparatus for testing or analyzing an integrated circuit (IC), comprising:
a dependency information reduction tool having a processor coupled to a memory;
wherein the dependency information reduction tool is adapted to:
receive generated information about a dependency between components of the IC based on a netlist describing the IC; and
reduce the generated information by at least one of:
combining portions of the information about components with a common dependency; and
eliminating a portion of the information about at least a first component that does not depend on another component of the IC.

10. The apparatus of claim 9 wherein:
the generated information includes a matrix of information about the dependency between components of the IC based on a netlist describing the IC; and
the dependency information reduction tool is further adapted to reduce the generated information by at least one of:
combining rows or columns of the information about components with a common dependency;
eliminating a row or a column of the information about at least a first component that does not depend on another component of the IC; and
at least one of add additional information to the generated information so as to enable further reduction of the generated information and duplicate a portion of the generated information so as to enable further reduction of the generated information.

11. The apparatus of claim 10 wherein the dependency information reduction tool is further adapted to:
add additional information to the generated information so that one or more portions of the additional information may be combined with a portion of the generated information; and
duplicate a portion of the generated information so that one or more portions of the duplicated information may be combined with a portion of the generated information.

12. A system for testing or analyzing an integrated circuit (IC), comprising:
a dependency information generation tool; and
a dependency information reduction tool coupled to the dependency information generation tool;
wherein the dependency information generation tool is adapted to generate information about a dependency between components of the IC based on a netlist describing the IC; and
wherein the dependency information reduction tool is adapted to reduce the generated information by at least one of:
combining portions of the information about components with a common dependency; and
eliminating a portion of the information about at least a first component that does not depend on another component of the IC.

13. The system of claim 12 wherein the system is adapted to employ the reduced information to test or analyze the IC.

14. The system of claim 12 wherein the system is adapted to reduce a number of tests or analyses employed to test or analyze the IC.

15. The system of claim 12 wherein:
the dependency information generation tool is further adapted to generate a matrix of information about the dependency between components of the IC based on a netlist describing the IC; and
the dependency information reduction tool is further adapted to reduce the generated information by at least one of:
combining rows or columns of information about components with a common dependency; and
eliminating a row or a column of information about at least a first component that does not depend on another component of the IC.

16. The system of claim 15 wherein the dependency information reduction tool is further adapted to:
add additional information to the generated information so as to enable further reduction of the generated information by adding additional information to the generated information so that one or more portions of the additional information may be combined with a portion of the generated information; and
duplicate a portion of the generated information so as to enable further reduction of the generated information by duplicating a portion of the generated information so that one or more portions of the duplicated information may be combined with a portion of the generated information.

17. A method of improving a process, comprising:
generating information about a dependency between sub-processes of the process; and
reducing the generated information by at least one of:
combining portions of the information about sub-processes with a common dependency; and
eliminating a portion of the information about at least a first sub-process that does not depend on another sub-process of the process.

18. The method of claim 17 further comprising employing the reduced information to test or analyze the process.

19. A method of improving a structure, comprising:
generating information about a dependency between components of the structure; and
reducing the generated information by at least one of:
combining portions of the information about components with a common dependency; and
eliminating a portion of the information about at least a first component that does not depend on another component of the structure.

20. The method of claim 19 further comprising employing the reduced information to test or analyze the structure.

21. A computer program product, comprising:
a medium readable by a computer, the computer readable medium having computer program code adapted to generate information about a dependency between components of an IC based on a netlist describing the IC.

22. The computer program product of claim 21 wherein the computer program code is further adapted to generate a matrix of information about the dependency between components of the IC based on the netlist describing the IC.

23. A computer program product, comprising:
a medium readable by a computer, the computer readable medium having computer program code adapted to:
receive generated information about a dependency between components of the IC based on a netlist describing the IC; and
reduce the generated information by at least one of:
combining portions of the information about components with a common dependency; and
eliminating a portion of the information about at least a first component that does not depend on another component of the IC.

24. The computer program product of claim 23 wherein:
the generated information includes a matrix of information about the dependency between components of the IC based on a netlist describing the IC; and
the computer program code is further adapted to reduce the generated information by at least one of:
combining rows or columns of information about components with a common dependency; and
eliminating a row or a column of information about at least a first component that does not depend on another component of the IC.
